(19) United States
(12) Patent Application Publication
(10) Pub. No.: US 2005/0024402 A1
(43) Pub. Date: Feb. 3, 2005

(54) Transfer of data from a controller to an output device

(76) Inventors: Jason M. Quintana, Brush Prairie, WA (US); Carl Thomsen, Brush Prairie, WA (US); Matthew A. Shepherd, Vancouver, WA (US)

Correspondence Address: HEWLETT-PACKARD COMPANY;Intellectual Property Administration, P.O. Box 272400, Fort Collins, CO, 80527-2400, US

(21) Appl. No.: 10/632,883

(22) Filed: Jul. 31, 2003

(51) Int. Cl. B41J 29/38

(52) U.S. Cl. 347/12

(57) ABSTRACT

A method of transferring data from a controller to an output device is indicated, which includes providing input data that describes a firing pattern for an array of ink nozzles, the input data having a first portion and a second portion wherein the first portion is disposed in a first pattern, and the second portion is disposed in a second pattern that is at least substantially complementary to the first pattern. The second portion of the input data is removed so that the input data is compressed, and intermediate data corresponding to the compressed input data is sent to the output device. The output device expands the intermediate data at the output device based on at least one of the first and second patterns.

### BACKGROUND

The amount of processing power and memory in a printer may have significant impact on the printer's cost. Accordingly, printers with relatively small amounts of processing power and memory, termed sleek or dumb printers, have been offered as an economical alternative to smarter printers that cost more. These sleek printers shift much of the data processing for printing from the printer to a host controller.

Inkjet-based sleek printers may rely on the host controller to translate other data representations into nozzle-firing data. The nozzle-firing data then may be sent from the host controller to the sleek printer, for implementation by an ink delivery mechanism that positionally expels ink droplets from nozzles onto print media, such as sheets of paper, as specified by the nozzle-firing data. To reduce the amount of nozzle-firing data stored in the sleek printer, portions of the nozzle-firing data may be sent to the sleek printer based on the order in which the portions are implemented. In this way, the sleek printer may implement each portion of the nozzle-firing data soon after it is received and then discard the portion before the next portion is received. For example, a portion of nozzle-firing data held by a printer at any one time may define nozzle firing for a single side-to-side sweep or pass of the nozzles (and printhead(s)) across a sheet of paper, or a subset of the sweep.

In using a sleek printer, the amount of nozzle-firing data sent from the host controller to the printer, to complete a single sweep of the printhead across the sheet (single-sweep data), may be substantial. In particular, the amount of single-sweep data may be proportional to a product of the number of nozzles on the printhead(s) and the number of positions at which the nozzles may be fired during the sweep. For example, an array of 600 nozzles may be fired at about 3600 positions for each nozzle during a six-inch side-to-side sweep across a page. This firing may be specified by an array of about 2.2 million data elements. As indicated by this example, the amount of nozzle-firing data received from the host controller before and/or during each sweep may exceed the input-output capacity of the sleek printer. Accordingly, sleek printers may be restricted in the portion of a sweep specified at any one time and may require a storage buffer to store part of the sweep data.

### BRIEF DESCRIPTION OF THE DRAWINGS

FIG. 1 is a perspective view of a system for transferring data from a host controller to a printer, in accordance with an embodiment of the invention.

FIG. 2 is a schematic representation of the system of FIG. 1.

FIG. 3 is a flowchart of two methods for transferring print data from a host controller to a printer, using masks to resolve the print data into portions that are sent to the printer and printed as interlaced patterns during sequential overlapping sweeps of a printhead over print media, in accordance with an embodiment of the invention.

FIG. 4 is an array of exemplary print data, in accordance with an embodiment of the invention.

FIG. 5 is a set of selection masks tiled to correspond to the print data of FIG. 4, in accordance with an embodiment of the invention.

FIG. 6 is a masked form of the print data of FIG. 4.

FIG. 7 is compressed print data produced by removal of the invalid data elements from the masked form of FIG. 6, in accordance with an embodiment of the invention.

FIG. 8 is expanded data produced by expansion of the compressed print data of FIG. 7, based on the valid pattern defined by the selection masks of FIG. 5, in accordance with an embodiment of the invention.

### DETAILED DESCRIPTION

A system for transfer of compressed data is provided that may be suitable for multi-pass or multi-sweep printing. In multi-pass printing, all ink droplets destined for an underlying region (swath) of the page may not be fired during one sweep: a single sweep of the printhead over the region may deposit only a fraction of the ink droplets for the region. In particular, inkjet printing may rely on multiple overlapping sweeps of the printhead over the same region to deposit interlaced patterns of ink droplets within the region. The use of multiple sweeps may reduce banding or other printing defects that may be produced when all ink droplets for the region are deposited during a single sweep over the region.

Masks may be used to mask print data, that is, to assign portions of print data to different overlapping sweeps of the printhead. Each mask may select a pattern of data elements within the print data for which the data elements are valid for a particular sweep of the printhead. The pattern of data elements may correspond to one of the interlaced patterns to be printed. The remaining data elements, in a complementary pattern, may be invalid for that sweep. Accordingly, a majority of the nozzle-firing data sent to a sleek printer for the sweep may correspond to invalid data elements that do not directly specify nozzle firing. Instead, the majority may serve only as placeholders that position the rest of the nozzle-firing data that is valid and may describe nozzle firing. Positional information specified by the placeholders may be redundant within each mask or within a set of tiled masks. Sleek printers may be slowed or overloaded by mask-derived positional information that is specified redundantly in the data received from the host controller. Therefore, a system is described herein that compresses data by removing redundant information specified by masks before sending the data to an output device.

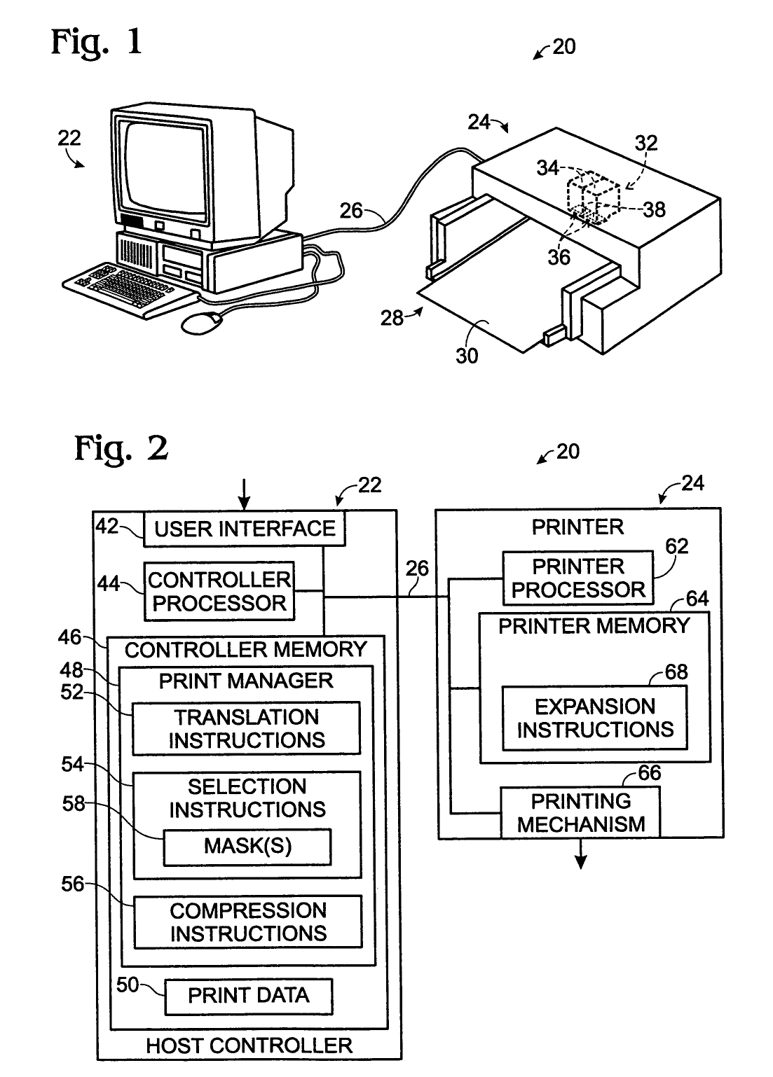

FIG. 1 shows a system 20 for transferring print data from a host controller 22 to an output device, such as a printer 24. The system may send compressed versions of the masked print data from host controller 22 to printer 24 through communications link 26. Printer 24, or another suitable output device, may expand and output the portions, for example, as printed output 28 formed with print media 30.

Host controller 22 may be any computing device configured to store, manipulate, and send print data to printer 24. The host controller, also termed a controller, may be a personal computer (such as a desktop or laptop device), a mainframe computer, a personal digital assistant, a digital phone, a photocopier, a facsimile machine, etc.

Printer 24 may be any device configured to output data received from the host controller. As used herein, outputting data means producing a representation of such data that is configured to be sensed by a person, for example, as a visible image(s), an audible sound(s), and/or the like. Accordingly, the output device may be a printer, a monitor, a television, a projector, or an audio device (for example, a stereo, a radio, a public address system, etc.). When the output device is a printer, the printer may print by any suitable mechanism. For example, the printer may be an inkjet printer, a laser printer, or a dot matrix printer, among others.

FIG. 1 shows printer 24 as an inkjet printer with a colorant delivery mechanism 32 configured to positionally deliver droplets of ink (or other colorant) to print media 30 (such as a sheet of paper). Colorant delivery mechanism 32 may include an ink supply mechanism, such as ink cartridges 34, and an array of nozzles 36 fluidly connected to the ink supply mechanism. Nozzles 36 may be defined by one or more printheads 38. The nozzles may be selectively operable, for example, by selectively activating heaters or piezo elements disposed adjacent the nozzles, to expel droplets from the nozzles as the colorant delivery mechanism moves relative to the print media.

The colorant delivery mechanism may move relative to the print media by any suitable relative movements. For example, in some embodiments, the printhead(s) of the colorant delivery mechanism may reciprocate between opposing side edges of the print media. In addition, the colorant delivery mechanism may advance print media orthogonal to the reciprocating motion of the printhead, generally lengthwise along the print media. However, in other embodiments, the printhead may remain stationary as the print media is moved, or the print media may remain stationary as the printhead moves.

Communications link 26 may include any connection that allows exchange of data, particularly print data, between host controller 22 and printer 24. Exemplary connections may include electrically conductive connections (such as wires or cables), optical connections (such as with a fiber-optic cable), and/or wireless connections that exchange data through air (for example, using electromagnetic radiation such as microwaves, infrared signals, radio waves, etc.). Communications link 26 may include a LAN (local area network), a WAN (or wide area network, such as the Internet), or may be a direct connection.

FIG. 2 shows a schematic representation of system 20, including host controller 22 and printer 24.

Host controller 22 may include a user interface 42, a controller processor 44, and controller memory 46, which are coupled to one another. User interface 42 may be any mechanism for receiving inputs from a person operating the host controller. The user interface may include a keyboard, a mouse, a keypad, a touch screen, etc. Controller processor 44 may be any device capable of receiving data from user interface 42, controller memory 46, and/or printer 24, and of performing digital manipulation of such data, such as arithmetic and logic operations, among others. The controller processor also may be configured to send data to the printer. Controller memory 46 may be virtually any mechanism for storing data, including, but not limited to ROM (such as EEPROM or flash memory), RAM, tape, and/or any other magnetic, electronic, and/or optical storage device(s) or media. Controller memory 46 may include, but is not limited to, a print manager 48 and print data 50.

Print manager 48 may be any mechanism configured to create print data 50 and/or derive compressed data from the print data, for transfer to printer 24. Accordingly, print manager 48 may include translation instructions 52 to translate and/or rasterize initial data into input or print data 50 that is recognizable by printer 24. In some embodiments, translation instructions 52 may translate a data representation into print data that defines a nozzle firing pattern relative to print media.

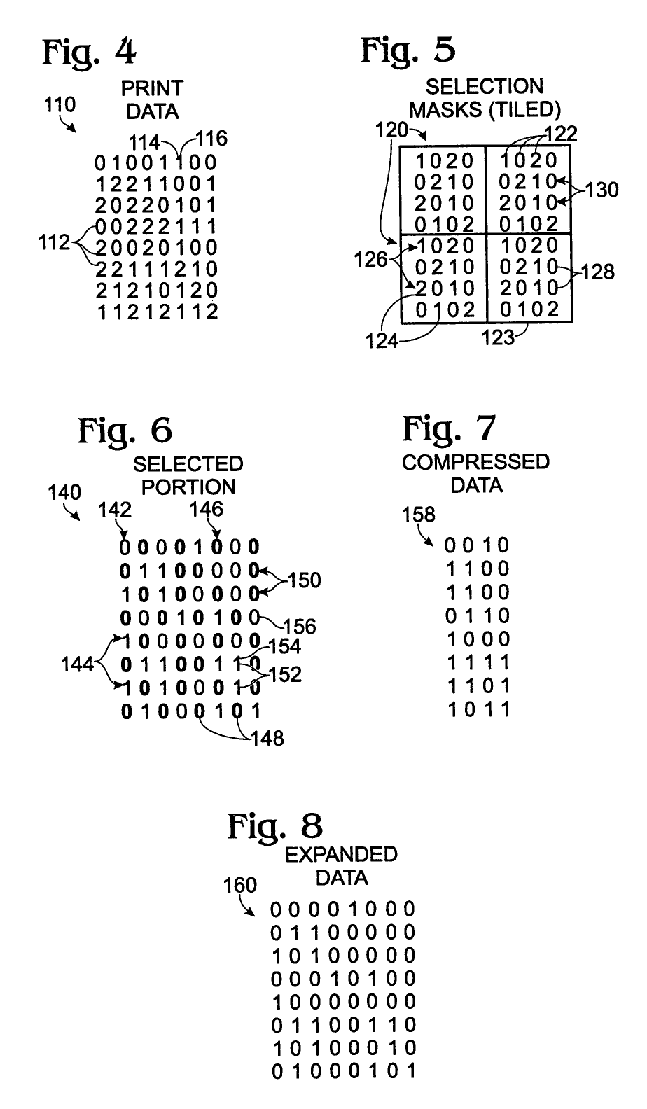

Print manager 48 also may include selection instructions 54 and compression instructions 56. Selection instructions 54 may be instructions for resolving the print data into a plurality of interlaced portions defining sequential sweeps, generally using one or more predefined masks 58. As used herein, a mask is any mechanism employed to select or specify valid and invalid portions of print data, disposed in complementary patterns within the print data. The valid portion may specify nozzle firing, whereas the invalid portion may not specify nozzle firing. Masks and the use of masks to select interlaced portions are described in more detail below in relation to FIGS. 4-8.

Compression instructions 56 may be instructions for reducing the amount of print data, or intermediate data derived from the print data, that is sent to printer 24. For example, compression instructions 56 may delete and/or remove the invalid portion specified by each mask, before and/or during sending the complementary valid portion to the printer. In addition, compression instructions 56 may be configured to perform additional compression of the print data. Such further compression may be performed, for example, by run-length encoding and/or by any other suitable compression method. In some embodiments, some or all of the compression instructions may be included in the selection instructions, that is, compression may be conducted as a valid portion is selected.

Print manager 48 also may include any suitable additional instructions for modifying print data or data derived therefrom. Such additional instructions may be implemented as part of the translation, selection, and/or compression instructions, or may be implemented separately. Accordingly, the additional instructions may be implemented at any time before sending compressed data to the printer, that is, before, during, and/or after selecting a valid portion and removing an invalid portion of the print data.

The additional instructions may specify operations on individual data elements within the print data or data portion, including logical or arithmetic transformation of values associated with the elements. Such transformation of values may be suitable, for example, when data elements specify values that are resolved into different sweeps of the colorant delivery mechanism (or other output mechanism). FIG. 6 presents an example of such a transformation of values as print data is masked.

Alternatively, or in addition, the additional instructions may specify reformatting of the print data (or data derived therefrom) to conform to a different output resolution or format. Such reformatting may be suitable when individual data elements of the print data do not correspond directly to individual output positions. For example, the print data may be denser than the output density (such as a 900 by 900 array of data elements specifying printing by a 300 by 300 array of nozzle positions). In this case, a subset of the data elements may need to be deleted (and/or their values averaged) to specify firing of nozzles in the 300 by 300 array. In another alternative, the print data may be less dense than the output density (such as 150 by 150 array of data elements to be printed by the 300 by 300 array of nozzle positions). In this case, data elements (and their associated values) may need to be duplicated at each position within the data element array to produce firing data, or null data elements may need to be interspersed with data elements of the print data to expand the print data into firing data. In either case, the number of data elements in the print data is changed. In some embodiments, the reformatting may specify a transposition of the data elements and their values, for example, converting rows of elements into columns, among others. Further aspects of data elements, data positions, and data values are described below in relation to FIG. 4.

Print data 50 may be any input data configured to specify positional output, for example, specifying nozzle firing positions relative to print media. In some embodiments, the print data may be firing data, that is, data having a direct correspondence to spatial positions on the print media, for example, with the print data in a two-dimensional array of data elements specifying print information in a corresponding array on the print media. The print data may correspond to any suitable subset of a larger set of print information, for example, specifying a region of printed output on print media of any suitable size or shape. For example, the print data may specify all ink droplets to be deposited on a swath of the print media having a height corresponding to a nozzle array, a portion of the swath, a smaller array of ink droplets, etc.

Printer 24 may include a printer processor 62 coupled to printer memory 64 and a printing mechanism 66. Printer processor 62 may include any mechanism configured to manipulate data received from printer memory 64 and/or host controller 22, particularly compressed data sent from the controller. In some embodiments, printer processor 62 may have substantially reduced processing power relative to controller processor 44 and/or may be configured to perform less than or equal to about 32 million or about 16 million operations per second (32 MHz or 16 MHz). Printers with such relatively slow printer processors are defined herein as sleek printers.

Printer memory 64 may be virtually any mechanism for storing information. In particular, the stored information may be data derived from compressed data, and/or expanded data produced by expanding the compressed data received from the host controller. In some embodiments, printer memory 64 may have a size configured to act as a data buffer for print data corresponding to a single sweep, more than one sweep, or less than one sweep, among others. Accordingly, printer memory 64 may have less storage capacity than memory in other types of printers that perform substantial onboard processing.

Printer memory 64 also may include expansion instructions 68. The expansion instructions may be any instructions that specify how compressed data should be expanded. As used herein, expanding data involves any increase in the number of data elements in the data. The expansion instructions may expand compressed data received from host controller 22, based on the mask used originally by the host controller to select a portion of the print data to be ignored and/or removed (and/or based on the pattern of the data portion selected with the mask). The expansion instructions may include a copy of the mask used by the controller to mask print data before sending or transmitting the print data to the printer. The expansion instructions may be stored or retained local to the printer, for example, in non-volatile memory of the printer. Further aspects of data expansion are described below in relation to FIG. 8.

Printing mechanism 66 may be any mechanism(s) for implementing data to create printed output. Accordingly, the printing mechanism may include suitable mechanisms for depositing colorants positionally on print media, such as colorant delivery mechanism 32 of FIG. 1.

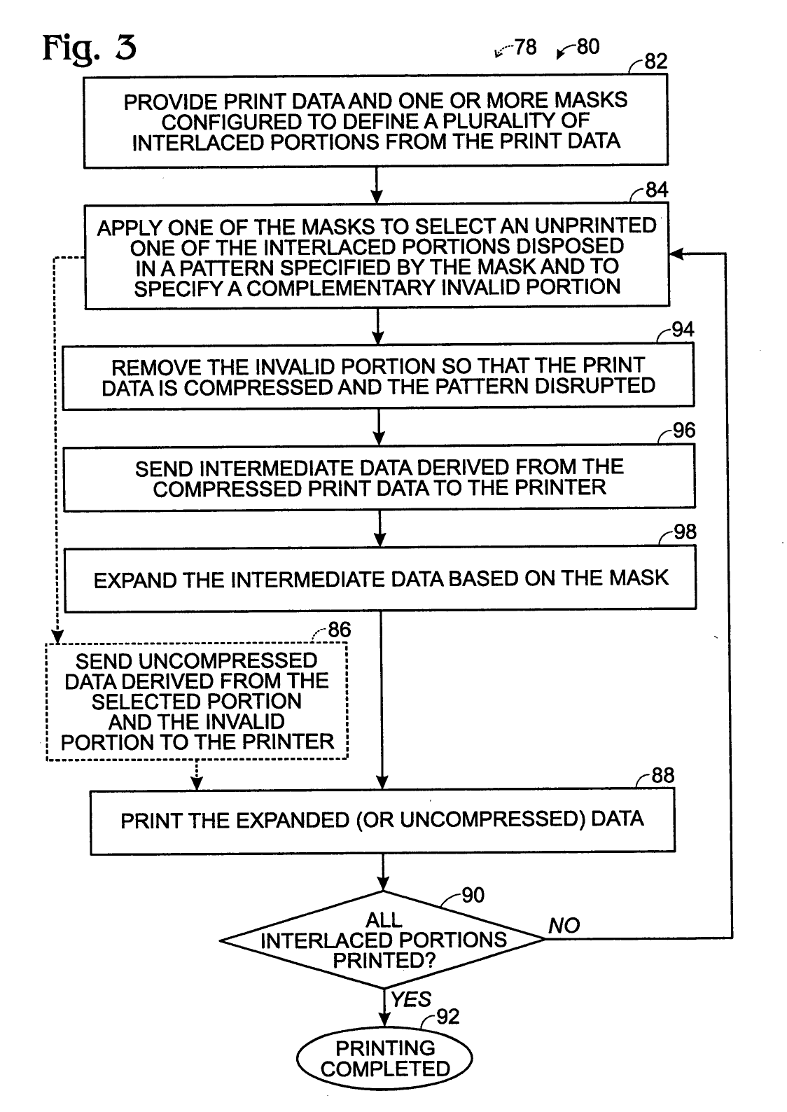

FIG. 3 shows two related methods 78, 80 for transferring print data from a host controller to a printer. Each method may use one or more masks to resolve the print data into valid portions that are sent to the printer and printed as interlaced patterns during sequential sweeps of a printhead over print media. Methods 78, 80 may be suited for directing multi-sweep printing on regions of the print media.

Method 78 may include providing print data and one or more masks, as shown at 82. The print data may be configured, as described above, by translation from a nonrasterized form, or by reformatting to correspond directly to an output format, and may specify a substantially contiguous portion of printed output. The one or more masks may be configured to define a plurality of interlaced or overlapping portions from the print data. Such portions may be printed in interlaced patterns during different sweeps of the nozzles over the same region of print media, a process termed shingling.

As used herein, interlaced means interspersed within a common region. Accordingly, interlaced data portions may be interspersed substantially or partially within the same array of print data. Similarly, interlaced droplet patterns may be deposited substantially within the same region of print media, for example, with no advancement of the print media between sweeps, to provide page-based shingling. Alternatively, the interlaced patterns may be deposited within partially overlapping regions, for example, with advancement of the print media a distance less than the length of the nozzle array, to provide pen-based shingling. Any other suitable form of shingling may be applied to the print data and the ink droplet patterns. In addition, interlaced droplet patterns may provide no overlap of individual ink droplets, up to partial or complete overlap of any suitable number of individual ink droplets.

One of the masks may be applied to select an unprinted one of the interlaced portions, as shown at 84. Applying the mask may select a portion of the print data, in a pattern, as valid. The valid portion or a subset thereof may be used to specify nozzle-firing positions, in a generally corresponding or related pattern, at the printer. An invalid portion in a complementary pattern also may be specified by applying the mask. The invalid portion may not be used directly to specify nozzles that fire. Accordingly, data elements of the invalid portion may be set at a common value or set of values, such as a null value (zero). Data elements of the valid and invalid portions may be interspersed with one another, that is, provided by overlapping sections of the print data.

Uncompressed data derived from the selected (or valid) portion and invalid portion may be sent to the printer, as shown at 86. The uncompressed data may be equivalent to the valid and invalid portions or may be altered by duplication, transformation, transposition, etc. of data elements and/or values. In any case, the invalid portion may provide a positional, placeholder function to position the data elements of the valid portion.

The uncompressed data may be printed, as shown at 88. The host controller (or printer) then may determine whether all of the interlaced portions have been printed, as shown at 90. If not one of the masks again may be applied (84) to select another unprinted one of the interlaced portions. If so, method 78 may be stopped, or additional print data may be provided by returning to operation 82 to initiate method 78 again. The additional print data may be partially overlapping with the print data from which the interlaced portions were selected previously, for example, when the interlaced portions do not represent all of the print data. Alternatively, the additional print data may be nonoverlapping, for example, specifying adjacent or contiguous output.

Method 78 may be altered to create a modified method 80 in which masked data is compressed at the host controller and expanded at the printer. Modified method 80 may be followed by replacing the operation of sending uncompressed data (86) with operations shown at 94, 96, and 98.

In modified method 80, the invalid portion of the print data (or data derived therefrom) may be removed, as shown at 94. Removal or deletion may compress the print data and may disrupt the pattern of the selected portion. In some embodiments, operation 94 may be included in the operation of applying one of the masks (84).

Intermediate data derived from the compressed print data may be sent or transmitted to the printer, as shown at 96. Sending may be performed using a communications link. In some embodiments, sending may effect the operation of removing the invalid portion (94), for example, by selectively sending only data derived from the valid or selected portion. Intermediate data may be at least substantially or completely identical to the compressed print data or may be related by duplication, transposition, transformation, etc.

The intermediate data may be expanded based on the mask (and/or based on a pattern complementary to the mask, as shown at 98. Expansion may include introducing positional or placeholder information, corresponding to the invalid portion, into the intermediate data to properly pattern or position data elements in the intermediate data. Based on whether additional data manipulations that alter the pattern were performed on the valid portion before sending (such as duplication or transposition), the intermediate data may be restored to the pattern defined by the mask or to a related pattern determined in part by the additional data manipulations. In either case, the expansion instructions of the printer may be based on the mask used to select the valid portion. Expansion may restore the data sent at 96 to a form that is similar or identical to the uncompressed data of operation 86 in method 78. Accordingly, modified method 80 may differ from method 78 by removing the invalid portion at the host controller and re-inserting the invalid portion (in a mask configuration) at the printer. Furthermore, since the positional information specified by the invalid portion may be repetitive in nature, such positional information may be defined more succinctly at the printer than in the data sent from the host controller.

FIGS. 4-8 illustrate exemplary data manipulations that may be performed on print data according to modified method 80. In this illustration, the print data is being prepared for four-pass printing using page-based shingling and progressive multilevel masking of the print data. However, any other style of mask and method of processing multilevel data may be used. Selection, compression, and expansion of the print data for one pass (out of the four passes or sweeps) are shown. In the present illustration, the print data density (or resolution) is equal to the output density (or resolution), that is, each data element corresponds to a print-nozzle position during printing.

FIG. 4 shows an array of exemplary print data 110. Print data 110 may define, for example, the number of droplets to be deposited in a corresponding array of rows and columns on print media. The print data may include a plurality of data elements 112, each having a value and a position associated with the element. For example, the value indicated at 114 is “1” and the position indicated at 116 is the first row and sixth column within print data 110. The value may specify, for example, the number of droplets at that position, or may specify any other suitable aspect to be implemented by an output device. In the present embodiment, each data element has a value of zero, one, or two, signifying deposition of a corresponding number of ink droplets on print media at a position specified by the position of the data element in the print data.

In some embodiments, print data may be provided as an M by N (M×N) array or matrix of data elements. M and N are integers greater than one, and may be at least four or more. M and N may be equal to one another or unequal. This first array of data elements may be masked using a predefined mask to create a second array of M×N data elements. The second array may have a valid portion and an invalid portion. The valid portion may be transmitted to a printer. The invalid portion may be removed from the second array prior to transmission of the valid portion to the printer, to compress the print data. The printer may convert the valid portion to a third array of M×N print data elements using a copy of the predefined mask. The third array may be used to generate printed output. For example, the third array may describe firing of an M×N array of nozzles to create the printed output.

FIG. 5 shows a set of selection masks 120, also termed shingle masks, arrayed or tiled to correspond to print data 110. Each mask 120 may have any suitable size and shape defined by mask elements 122. In the present illustration, each mask 120 has a four-by-four array of mask elements 122. A border 123 around each array of mask elements delineates each mask for the sake of clarity. A single mask configuration may be duplicated and arrayed in contiguous fashion, or tiled, any suitable number of times to provide an array of mask elements that correspond in number and arrangement to the print data. In the depicted embodiment, mask 120 is present four times.

Each selection mask 120 may perform one or more operations on print data 110. The selection mask may select a valid portion of the data using valid mask elements 124 (represented by a “1” or a “2” in this example). The presence of a “1” or a “2” in the mask determines how valid print data elements will be processed. Valid mask elements 124 define a pattern 126 in which print data elements 112 of the print data are specified as valid. The selection mask also may specify an invalid portion of the print data using invalid mask elements 128 (represented by “0”). The invalid mask elements may define a complementary pattern 130 in which data elements 112 are invalidated. As used herein, valid means that the value of each data element is considered in specifying an output (or lack thereof). Accordingly, a valid portion of the print data defines a set of data elements for which the associated value of each data element is considered as potential output. By contrast, an invalid portion of the print data defines a set of data elements that are not considered in specifying the output. Accordingly, an invalid data portion defines a set of invalid data elements for which the associated values are irrelevant, for example, set to zero irrespective of the values initially associated with such data elements.

Selection mask 120 also may modify the values of valid data elements in selection of a valid portion (for example, by changing a “2” to a “1” or a “1” to a “0”), to enable proper distribution of output between different passes, as described below. In some embodiments, masking print data, and modification of valid data elements, may be conducted in separate operations.

FIG. 6 shows a masked form 140 of the print data of FIG. 4 after selection of a valid portion and specification of an invalid portion by application of masks 120. Valid portion 142 is represented in this illustration by data elements shown in standard type. Valid portion 142 may have a valid data pattern 144 corresponding to valid mask pattern 126 (FIG. 5). Invalid portion 146 may be defined by invalid data elements 148 shown in bold type, according to values associated with mask elements at corresponding positions. Each invalid data element 148 has been set to a value of zero, irrespective of the value initially associated with such data element (compare with FIG. 4). Invalid portion may have an invalid data pattern 150 that is complementary to valid data pattern 144 and corresponding to invalid mask pattern 130 (FIG. 5).

By contrast, valid data elements 152 have been assigned values based on the values initially associated with the valid data elements. In particular, each valid data element has been assigned a value of “1” or “0” to specify whether or not a corresponding nozzle will be fired at the position defined by such valid element. Valid elements having an initial value of “0” may specify not to fire a nozzle, and are maintained at “0.” Valid elements having an initial value of “2” are assigned a value of “1” to specify nozzle firing, irrespective of the value associated with the corresponding valid mask element. However, valid data elements having an initial value of “1” may be assigned a value based on the value associated with each corresponding valid mask element. In the present illustration, a valid mask element with a value of “1” assigns a value of “1” to the corresponding data element, shown at 154, specifying nozzle firing. In addition, a valid mask element with a value of “2” assigns a value of “0” to the corresponding data element, shown at 156, specifying not to fire the nozzle. Instead, the firing of a nozzle specified by such valid data element may be implemented during selection of the data element as valid for another one of the overlapping passes.

FIG. 7 shows compressed data 158 produced from selected valid portion 142 (FIG. 7) after removal of invalid portion 146. Removal of invalid portion 146 may be conducted, for example, by deleting invalid data elements 148, and results in disruption of valid data pattern 144 and compression of the print data. The compressed data may be sent directly to the printer as intermediate data or may be modified further before being sent as intermediate data, for example, by further compression or other data manipulations.

FIG. 8 shows expanded data 160 produced from compressed data 158 after the compressed data was received by a printer and expanded using expansion instructions. More particularly, data corresponding to the compressed portion may be expanded at the printer based on valid mask pattern 126 (and/or invalid mask pattern 130). Expansion may include, for example, insertion of data elements having null values at a set of positions within the compressed data, based on the invalid pattern defined by mask 120 (FIG. 5). Stated in another way, expansion may include placing the compressed data in its original pattern based on the valid pattern defined by the mask.

It is believed that the disclosure set forth above encompasses multiple distinct embodiments of the invention. While each of these embodiments has been disclosed in specific form, the specific embodiments thereof as disclosed and illustrated herein are not to be considered in a limiting sense as numerous variations are possible. The subject matter of this disclosure thus includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

1. A method of transferring data from a controller to an output device, comprising:
providing input data that describes a firing pattern for an array of ink nozzles, the input data having a first portion and a second portion, the first portion being disposed in a first pattern and the second portion being disposed in a second pattern that is at least substantially complementary to the first pattern;
removing the second portion of the input data so that the input data is compressed; and
sending intermediate data corresponding to the compressed input data to the output device;
wherein the output device expands the intermediate data at the output device based on at least one of the first and second patterns.

2. The method of claim 1, wherein providing includes selecting the first portion, and wherein selecting, removing, and sending are conducted a plurality of times to resolve the input data into a plurality of different portions configured to specify interlaced patterns of an output.

3. The method of claim 1, wherein the output device expands the intermediate data by inserting invalid data elements into the intermediate data based on a predefined mask that specifies the invalid data elements.

4. The method of claim 1, wherein the compressed input data includes a set of data elements having associated values, the set having a size corresponding to a total number of the data elements in the set,
the method further comprising producing the intermediate data from the compressed input data by at least one of changing the size of the set, transforming one or more of the associated values, and further compressing the compressed input data.

5. The method of claim 1, wherein the output device expands the intermediate data so that the intermediate data is disposed in a third pattern, the third pattern being related to but different from the first pattern.

6. The method of claim 1, wherein removing provides a first compression of the input data, the method further comprising performing a second compression of the input data before sending.

7. The method of claim 1, wherein removing the second portion includes masking the second portion using a mask so that the first portion is unmasked.

8. The method of claim 1, wherein sending the intermediate data includes sending the compressed input data without modification to the output device.

9. The method of claim 1, wherein the output device is a printing device, and wherein providing, removing, and sending are conducted by a controller that is separate from the printing device.

10. A method of transferring data for printing, comprising:
providing print data at a controller, the print data having a plurality of data elements specifying positions for colorant placement onto print media by a printing device;
applying a mask to the print data to specify an invalid portion of the data elements;
removing the specified invalid portion of the data elements from the print data to compress the print data; and
sending intermediate data corresponding to the compressed print data to the printing device from the controller;
wherein the printing device expands the intermediate data based on the mask; and
wherein the printing device prints at least a subset of the expanded intermediate data.

11. The method of claim 10, wherein the printing device has a printhead with an array of nozzles, wherein applying the mask further specifies a remaining valid portion that defines a firing arrangement for a subset of the nozzles, and wherein the printing device prints the subset of the expanded intermediate data by ejecting ink droplets from the array of nozzles onto the print media according to the firing arrangement.

12. The method of claim 11, wherein the data elements of the print data have values, the method further comprising changing the values of at least a subset of the valid portion before sending.

13. The method of claim 10, wherein applying, removing, and sending are conducted a number of times on the print data to produce a corresponding number of interlaced patterns of printed output.

14. The method of claim 10, wherein the printing device is configured to expand the intermediate data by inserting invalid data elements into the intermediate data based on the mask.

15. The method of claim 10, wherein the data elements of the invalid portion are present a number of times and have associated values, the method further comprising producing the intermediate data by at least one of changing the number, changing at least a subset of the associated values, and further compressing the compressed print data.

16. The method of claim 10, wherein the printing device expands the intermediate data by disposing the intermediate data in a pattern, the pattern being defined by the mask.

17. The method of claim 10, wherein removing provides a first compression, the method further comprising performing a second compression of the compressed print data before sending.

18. A system for transferring print data to a printing device, comprising:
a controller configured to select a first portion of print data disposed in a first pattern and to remove a second portion of the print data disposed in a second pattern that is complementary to the first pattern so that the print data is compressed; and
a printing device configured to receive intermediate data corresponding to the compressed print data and to expand the intermediate data based on at least one of the first and second patterns, the printing device being configured further to print at least a subset of the expanded intermediate data.

19. The system of claim 18, wherein the printing device is an ink-jet printing device.

20. The system of claim 18, wherein the printing device is configured to expand the intermediate data by inserting data elements into the intermediate data based on the second pattern.

21. A printing device for printing expanded data produced from intermediate data received from a controller, the intermediate data corresponding to print data that is compressed by retaining a first portion of the print data disposed in a first pattern and removing a second portion of the print data disposed in a second pattern that is complementary to the first pattern, the printing device comprising:
a processor configured to receive the intermediate data and to expand the intermediate data based on at least one of the first and second patterns; and
a colorant delivery mechanism coupled with the processor and configured to deliver colorant to print media according to the intermediate data after such intermediate data is expanded by the processor.

22. The printing device of claim 21, further comprising expansion instructions that instruct the processor in expanding the intermediate data based on the at least one pattern.

23. A program storage device readable by a processor, tangibly embodying a program of instructions executable by the processor to perform method steps for transferring data from a controller to an output device, the method steps comprising:
providing input data having a first portion and a second portion, the first portion being disposed in a first pattern and the second portion being disposed in a second pattern that is at least substantially complementary to the first pattern;
removing the second portion of the input data so that the input data is compressed;
sending intermediate data corresponding to the compressed input data to the output device; and
expanding the intermediate data at the output device based on at least one of the first and second patterns.

24. A method of transmitting data to a printing device, comprising:
providing a first array of M×N print data elements;
applying a predefined mask to the first array so as to create a second array of M×N print data elements, the second array including a valid portion and an invalid portion; and
transmitting the valid portion to a printing device,
wherein the printing device uses a copy of the predefined mask to convert the valid portion into a third array of M×N print data elements, and
wherein the printing device generates printed output according to the third array of print data elements.

25. The method of claim 24, wherein the third array of print data elements describes a firing pattern for an M×N array of ink nozzles in the printing device.

26. The method of claim 24, wherein the printing devices retains the copy of the predefined mask in non-volatile memory local to the printing device.

27. The method of claim 24, wherein the valid portion is compressed prior to transmission to the printing device.

28. The method of claim 24, wherein M is equal to N.
